(19) United States
(12) Patent Application Publication
(10) Pub. No.: US 2012/0195451 A1
(43) Pub. Date: Aug. 2, 2012

(54) WATERPROOF STRUCTURE FOR ELECTRONIC DEVICE

(75) Inventors: Mie Nakata, Osaka (JP); Nobuaki Iwamoto, Osaka (JP); Tetsurou Takeda, Osaka (JP)

(73) Assignee: SANYO ELECTRIC CO., LTD., Moriguchi City (JP)

(21) Appl. No.: 13/360,231

(22) Filed: Jan. 27, 2012

(30) Foreign Application Priority Data
Jan. 31, 2011 (JP) 2011-019062

(51) Int. Cl. H04R 1/02

(52) U.S. Cl. 381/334

(57) ABSTRACT

A waterproof structure for an electronic device according to the present invention includes: a housing in which a sound-transmitting hole is formed; a sound producing member and/or sound collecting member stored at a position facing the sound-transmitting hole in the housing; a sheet of nonwoven fabric arranged from the outside of the housing to seal the sound-transmitting hole; and a water-proofing sheet arranged on an outer surface of the sheet of nonwoven fabric.

### CROSS-REFERENCE TO RELATED APPLICATIONS

This application claims the priority to Japanese Patent Application No. 2011-19062 filed on Jan. 31, 2011, the disclosure of which is incorporated herein by reference.

### BACKGROUND OF THE INVENTION

1. Field of the Invention

The present invention relates to a waterproof structure for an electronic device and, more particular, to a waterproof structure for an electronic device including a sound producing member and/or a sound collecting member.

2. Description of the Related Art

An electronic device that includes a sound producing member such as a loudspeaker unit and/or a sound collecting member such as a microphone unit and has functions of recording sound, reproducing sound, performing speech communication, and the like therein is known.

A sound producing member and a sound collecting member are stored in a housing of an electronic device. However, in order to improve a sound-transmitting property, a sound-transmitting hole is generally formed at a position facing the sound producing member or a sound collecting member in the housing.

In recent years, an electronic device having a high water-proofing property is desired. However, since a sound-transmitting hole is required to secure a sound-transmitting property, an electronic device in which a sound-transmitting hole is sealed with a single-layer water-proofing sheet having a moisture permeability is proposed.

Since the water-proofing sheet has a elasticity, when a water pressure is applied on the electronic device from outside in a case where the electronic device is submerged, the water-proofing sheet extends with the water pressure, and sound properties of the sound producing member and the sound collecting member inside the water-proofing sheet may be deteriorated. Furthermore, the water-proofing property may be deteriorated.

Thus, a mesh sheet made of a metal material may be fixed on a rear-surface side of the water-proofing sheet, i.e., on a sound-transmitting hole side to prevent the water-proofing sheet from extending. However, sound transmittance may be deteriorated by interposing the mesh sheet. When a water pressure is applied to cause the water-proofing sheet to extend toward the sound-transmitting hole, the water-proofing sheet is brought into press contact with wire rods constituting the mesh. For this reason, the water-proofing sheet is subjected to the load, and the water-proofing sheet may be damaged.

### SUMMARY OF THE INVENTION

A waterproof structure for an electronic device according to the present invention includes: a housing in which a sound-transmitting hole is formed; a sound producing member and/or sound collecting member stored at a position facing the sound-transmitting hole in the housing; a sheet of nonwoven fabric arranged from the outside of the housing to seal the sound-transmitting hole; and a water-proofing sheet arranged on an outer surface of the sheet of nonwoven fabric.

### BRIEF DESCRIPTION OF THE DRAWINGS

FIG. 1 is an exploded perspective view of a digital camera equipped with a waterproof structure for an electronic device according to one embodiment of the present invention; and

FIG. 2 is a sectional view along a line A-A in FIG. 1.

### DETAILED DESCRIPTION OF THE PREFERRED EMBODIMENTS

A digital camera 10 to which a waterproof structure for an electronic device according to one embodiment of the present invention is applied will be described below. However, the waterproof structure for an electronic device according to the present invention can be applied to not only the digital camera 10, but also a cellular phone having recording and reproducing functions and a speech communication function, acoustic equipment such as a video camera or an IC recorder, and another electronic device, as a matter of course.

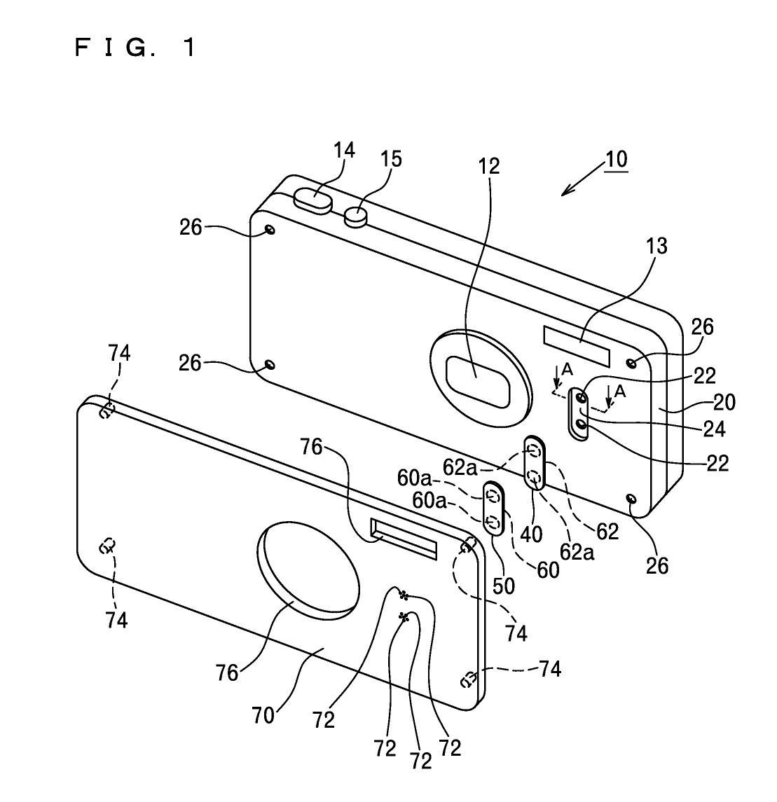

FIG. 1 is an exploded perspective view showing the digital camera 10 when viewed from a diagonally forward side. As the digital camera 10, a device that can take an image or a moving image, can record sound or the like in photographing, and can reproduce the sound or the like can be illustrated.

The digital camera 10 is configured such that main parts of the digital camera are stored in a housing 20.

As shown in FIG. 1, on a front surface side of the housing 20, a lens unit 12 protrudes at almost the center, and a flash unit 13 protrudes on a diagonally upper side of the lens unit 12. The housing 20 includes a shutter release button 14 and a mode selecting knob 15 that switches various modes such as a photographing mode and a reproducing mode. In addition, on a rear surface of the housing 20, a liquid crystal monitor (not shown) or the like is arranged.

In the housing 20, on a side of the lens unit 12 and in the lens unit 12, sound-transmitting holes 22, 22 that transmit sound from a microphone unit 30 serving as a sound producing member stored in the housing 20 to the outside and guide external sound to a loudspeaker unit 32 serving as a sound collecting member are formed to penetrate the housing.

In the illustrated embodiment, the sound-transmitting holes 22, 22 are formed in a vertically long concave portion 24 formed in the front surface of the housing 20 to penetrate the front surface.

The concave portion 24 is formed around the sound-transmitting holes 22, 22 to easily position a sheet of nonwoven fabric 40 and a water-proofing sheet 50 (will be described later), to make it possible to prevent the sheet of nonwoven fabric 40 and the water-proofing sheet 50 from being displaced, and to prevent water from intruding from the periphery of the parts into the housing.

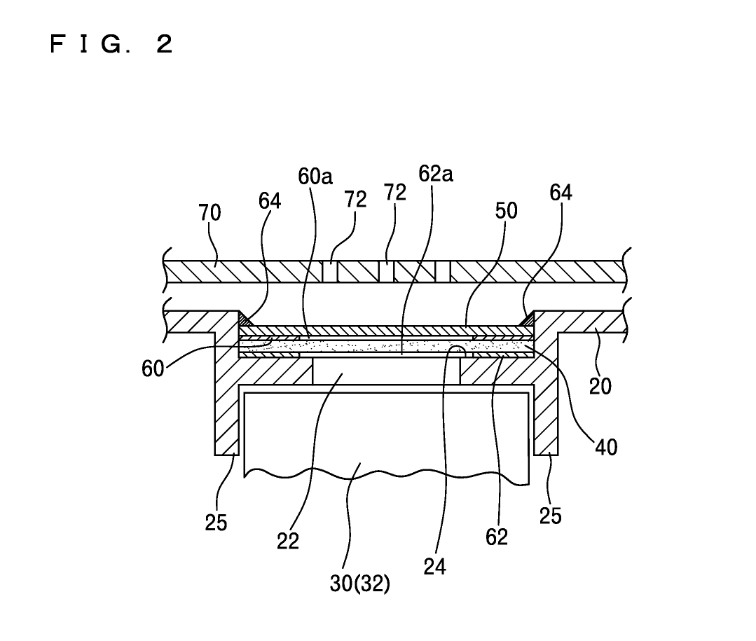

FIG. 2 is a sectional view along a line A-A in FIG. 1. As shown in FIG. 2, the microphone unit 30 is arranged inside the housing 20 to come close to the sound-transmitting holes 22 formed in the concave portion 24 of the housing 20. Although FIG. 2 is a sectional view a facing portion between the microphone unit 30 and one of the sound-transmitting holes 22, the loudspeaker unit 32 is arranged to face the other of the sound-transmitting holes 22 to come close to the sound-transmitting hole.

The microphone unit 30 and the loudspeaker unit 32 can be fixed to the housing 20 by being fitted in a circular rib 25 projecting from the rear surface of the housing 20.

The sheet of nonwoven fabric 40 is arranged on a side facing the sound-transmitting holes 22, 22 on the outside of the housing 20. Furthermore, a water-proofing sheet is arranged on the outside of the sheet of nonwoven fabric 40.

The sheet of nonwoven fabric 40 and the water-proofing sheet 50 desirably have almost the same shapes as those of an internal contour of the concave portion 24 when the concave portion 24 is formed on the edges of the sound-transmitting holes 22, 22. When the concave portion 24 is not formed, at least sound-transmitting holes 22, 22 may be sealed, and the sheet of nonwoven fabric 40 and the water-proofing sheet 50 may have sizes such that the sheet of nonwoven fabric 40 and the water-proofing sheet 50 can be fitted on the housing 20.

As the sheet of nonwoven fabric 40, it can be illustrated that a sheet of nonwoven fabric having a thickness of 0.1 to 1.0 mm and a density of 30 to 100 g/m³ is used. In the illustrated embodiment, as the sheet of nonwoven fabric 40, Himelon (registered trademark) having a thickness of 0.2 mm and a density of 30 g/m³ is used.

The water-proofing sheet 50 has an air permeability and a waterproofing property. As the water-proofing sheet 50, it can be illustrated that a water-proofing sheet having a thickness of 0.1 to 0.5 mm is used. In the illustrated embodiment, as the water-proofing sheet 50, Gore-Tex (registered trademark) having a thickness of 0.2 mm is used.

The sheet of nonwoven fabric 40 and the water-proofing sheet 50, as shown in FIGS. 1 and 2, are bonded to each other with an adhesive agent, a double-faced tape, or the like. In the drawing, reference numerals 60 and 62 denote adhesive layers configured by an adhesive agent, or a double-faced tape, or the like.

After the water-proofing sheet 50 is bonded to the sheet of nonwoven fabric 40 to be integrated with each other, the sheet of nonwoven fabric 40 is bonded to the bottom surface of the concave portion 24 in a state in which the sheet of nonwoven fabric 40 faces the housing 20 to make it possible to fix the water-proofing sheet 50 and the sheet of nonwoven fabric 40 to the housing 20 to seal the sound-transmitting holes 22, 22.

As a matter of course, after the sheet of nonwoven fabric 40 is bonded to the housing 20 in advance, the water-proofing sheet 50 may be bonded to the sheet of nonwoven fabric 40.

When the water-proofing sheet 50 and the sheet of nonwoven fabric 40 are bonded to each other and when the sheet of nonwoven fabric 40 and the housing 20 are bonded to each other, it is desired that the adhesive layers 60, 62 are not arranged on portions facing the sound-transmitting holes 22, 22, more desirably, portions 60a, 62a including the edges (about 0.1 to 0.2 mm) of the sound-transmitting holes 22.

This is because, when the water-proofing sheet 50 is bonded to the sheet of nonwoven fabric 40, the air permeabilities of the water-proofing sheet 50 and the sheet of nonwoven fabric 40 are hindered by an adhesive agent or the like, and the sound-transmitting property may be deteriorated.

On the sheet of nonwoven fabric 40 on the housing 20 side, the portion 62a on which the adhesive layer 62 is not formed is formed on the portion facing the sound-transmitting holes 22, 22 because the housing 20 to be bonded is not present. This is because the sound-transmitting property is prevented from being deteriorated by hindering the air permeability of the sheet of nonwoven fabric 40 by the adhesive agent or the like.

As shown in FIG. 2, after the sheet of nonwoven fabric 40 and the water-proofing sheet 50 are bonded to the concave portion 24 of the housing 20, an adhesive agent 64 having a water-proofing property is desirably circularly weld-overlaid along a contact portion between the edge of the water-proofing sheet 50 and the internal wall of the concave portion 24. In this manner, water can be prevented from intruding into the boundary portion between the edge of the water-proofing sheet 50 and the concave portion 24 as much as possible.

With the above waterproof structure of the configuration, water can be prevented from intruding from the sound-transmitting holes 22, 22 formed in the housing 20 into the housing 20 by the water-proofing sheet 50 and the sheet of nonwoven fabric 40.

For example, when the digital camera 10 is submerged in water to be used in water, or when the digital camera 10 is submerged against user's intension, the water-proofing sheet 50 prevents water from being transmitted upon application of an external water pressure. However, at this time, the water-proofing sheet 50 tends to expand toward the inside of the housing 20 by the water pressure. However, in the present invention, since the sheet of nonwoven fabric 40 is arranged inside the water-proofing sheet 50, the water-proofing sheet 50 does not inwardly expand because the water-proofing sheet 50 is supported by the sheet of nonwoven fabric 40. Thus, under the water pressure, damage on the water-proofing sheet 50 can be reduced as much as possible.

Since the sheet of nonwoven fabric 40 is finer than a mesh sheet made of a metal material, a contact area between the water-proofing sheet 50 and the sheet of nonwoven fabric 40 can be increased, and stress generated by pressing the water-proofing sheet 50 against the sheet of nonwoven fabric 40 can be dispersed to make it possible to suppress damage to the water-proofing sheet 50.

As shown in FIGS. 1 and 2, a cover 70 can be fixed to the front surface of the housing 20 for decoration and so on. In this case, in order to improve the sound-transmitting property, in the cover 70, one or more sound-transmitting holes 72, 72 are desirably formed in a portion facing the sound-transmitting holes 22, 22.

In the cover 70, through holes 76, 76 that cause the lens unit 12 and the flash unit 13 to protrude can be formed.

The cover 70 can be fixed to the housing 20 by engagement, screwing, adhesion, or the like. In the illustrated embodiment, engagement convex portions 74, 74 are arranged on the rear surface of the cover 70, engagement concave portions 26, 26 are formed on the front surface of the housing 20, and the engagement convex portions 74, 74 and the engagement concave portions 26, 26 are fitted to each other to fix the cover 70 to the housing 20.

In FIG. 2, a gap is formed between the housing 20 and the cover 70. However, in order to improve the water-proofing property, the housing 20 and the cover 70 may be in contact with each other.

The cover 70 is arranged to prevent a waterproof structure, especially, the water-proofing sheet 50 from being directly exposed to the outside, and can prevent the water-proofing sheet 50 from being damaged in contact with a fingertip of a user or another thing.

In the embodiment, the sheet of nonwoven fabric 40 is bonded to the housing 20, and the water-proofing sheet 50 is bonded to the sheet of nonwoven fabric 40. However, these members can also be fixed by welding or the like. In this case, in order to secure a sound-transmitting property to the sound-transmitting holes 22, 22, it is desired that welding or the like is not performed to a position facing the sound-transmitting holes 22, 22.

In the embodiment, the concave portion 24 is formed on the peripheries of the sound-transmitting holes 22, 22, and the sheet of nonwoven fabric 40 and the water-proofing sheet 50 are arranged. However, while the sheet of nonwoven fabric 40 and the water-proofing sheet 50 are directly stuck to the housing 20 or simply overlapped, the periphery of the water-proofing sheet 50 can be directly stuck to the housing 20 by sticking means such as a tape, as a matter of course.

The present invention is useful as an electronic device including a waterproof structure that can reduce damage to a water-proofing sheet caused by a water pressure.

What is claimed is:

1. A waterproof structure for an electronic device comprising:
a housing in which a sound-transmitting hole is formed;
a sound producing member and/or sound collecting member stored at a position facing the sound-transmitting hole in the housing, a sheet of nonwoven fabric arranged from the outside of the housing to seal the sound-transmitting hole; and
a water-proofing sheet arranged on an outer surface of the sheet of nonwoven fabric.

2. The waterproof structure for an electronic device according to claim 1, wherein the water-proofing sheet has an air permeability and a waterproofing property.

3. The waterproof structure for an electronic device according to claim 1, wherein the housing and the sheet of nonwoven fabric are joined to each other and the sheet of nonwoven fabric and the water-proofing sheet are joined to each other by adhesive layers formed on positions except for positions facing the sound-transmitting holes, respectively.

4. The waterproof structure for an electronic device according to claim 1, wherein the sound-transmitting hole is formed in a concave portion formed on an outer surface of the housing, and the sheet of nonwoven fabric and the water-proofing sheet are arranged in the concave portion.

5. The waterproof structure for an electronic device according to claim 4, wherein, after the water-proofing sheet is arranged in the concave portion, an adhesive agent is weld-overlaid along the edge of the water-proofing sheet.
